(19) United States
(12) Patent Application Publication
(10) Pub. No.: US 2026/0303173 A1
(43) Pub. Date: Oct. 1, 2026

(54) RESET CONDITION FOR USER EQUIPMENT-INITIATED BEAM MANAGEMENT

(71) Applicant: Nokia Technologies Oy, Espoo (FI)

(72) Inventors: Paolo BARACCA, Munich (DE); Mihai ENESCU, Espoo (FI); Keeth Saliya Jayasinghe LADDU, Espoo (FI); Andrew LAPPALAINEN, Murray Hill, NJ (US); Subin NARAYANAN, Oulu (FI)

(21) Appl. No.: 19/555,147

(22) Filed: Mar. 3, 2026

Related U.S. Application Data
(60) Provisional application No. 63/777,888, filed on Mar. 26, 2025.

(51) Int. Cl. H04B 7/06; H04W 80/02

(52) U.S. Cl. CPC H04B 7/0626; H04B 7/06968; H04W 80/02

(57) ABSTRACT

Example embodiments of the present disclosure are directed to a reset condition for a user equipment-initiated beam management (UEIBM). A method comprises receiving, from a second apparatus, a CSI report configuration indicating a condition for a trigger event comprising a new beam being measured to be a threshold value better than a reference beam; receiving, from a second apparatus, a MAC-CE for TCI activation indicating an update of a value associated with a reference beam; and resetting a counter associated with at least a new beam counting based on the reception of the MAC-CE and the CSI report configuration.

### CROSS-REFERENCE TO RELATED APPLICATION

This application claims priority from, and the benefit of, U.S. Provisional Application No. 63/777,888, filed Mar. 26, 2025, the contents of which are hereby incorporated by reference in their entirety.

### FIELD

Various example embodiments of the present disclosure generally relate to the field of telecommunication and in particular, to methods, devices, apparatuses and computer readable storage medium for a reset condition for a user equipment-initiated beam management (UEIBM).

### BACKGROUND

Some use cases where UE may benefit from initiating the UEIBM reporting are being identified, e.g., to facilitate beam switch. The UEIBM feature may refer to the case where the UE may be configured with at least one event/condition, and then the UE may start beam reporting if this at least one event/condition occurs or is satisfied.

### SUMMARY

In a first aspect of the present disclosure, there is provided a first apparatus. The first apparatus comprises at least one processor; and at least one memory storing instructions that, when executed by the at least one processor, cause the first apparatus to: receive, from a second apparatus, a CSI report configuration indicating a condition for a trigger event comprising a new beam being measured to be a threshold value better than a reference beam; receive, from a second apparatus, a MAC-CE for TCI activation indicating an update of a value associated with a reference beam; and reset a counter associated with at least a new beam counting based on the reception of the MAC-CE and the CSI report configuration.

In a second aspect of the present disclosure, there is provided a method. The method comprises: receiving, from a second apparatus, a CSI report configuration indicating a condition for a trigger event comprising a new beam being measured to be a threshold value better than a reference beam; receiving, from a second apparatus, a MAC-CE for TCI activation indicating an update of a value associated with a reference beam; and resetting a counter associated with at least a new beam counting based on the reception of the MAC-CE and the CSI report configuration.

In a third aspect of the present disclosure, there is provided a first apparatus. The first apparatus comprises means for receiving, from a second apparatus, a CSI report configuration indicating a condition for a trigger event comprising a new beam being measured to be a threshold value better than a reference beam; means for receiving, from a second apparatus, a MAC-CE for TCI activation indicating an update of a value associated with a reference beam; and means for resetting a counter associated with at least a new beam counting based on the reception of the MAC-CE and the CSI report configuration.

In a fourth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example of change of reference beam within the configured time window for Event-7 determination;

FIG. 3 illustrates a signaling chart of communication according to some example embodiments of the present disclosure;

FIG. 4 illustrates a flowchart of a method implemented at a first apparatus in accordance with some example embodiments of the present disclosure;

FIG. 5 illustrates a flowchart of a method implemented at a first apparatus in accordance with some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS), an access point (AP) or an transmission reception point (TRP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

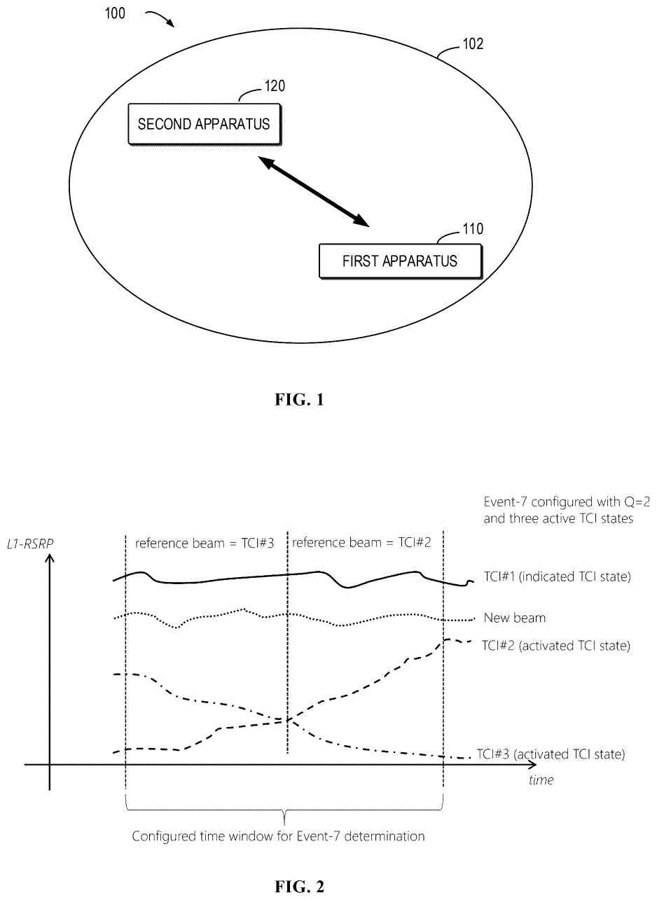

FIG. 1 illustrates an example communication network 100 in which example embodiments of the present disclosure can be implemented. As shown in FIG. 1, the communication network 100 may comprise a first apparatus 110 which may also be, for example, referred to as a terminal device or a UE.

The communication network 100 may further comprise a second apparatus 120, which may be, for example, considered as being a network device or being included in a network device. In some example embodiments, the network device may be discussed as a BS, a gNB, or an eNB.

A serving area provided by the second apparatus 120 is called a cell. The second apparatus 120 may provide one or more cells serving the first apparatus. For example, the first apparatus 110 may communicate with the second apparatus 120 within the cell 102. In some scenarios, the cell 102 may be considered as a cell that is serving the first apparatus 110.

In the following, for the purpose of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

In some example embodiments, if the first apparatus 110 is a terminal device and second apparatus 120 is a network device, a link from the second apparatus 120 to first apparatus 110 is referred to as a downlink (DL), while a link from the first apparatus 110 to second apparatus 120 is referred to as an UL. In DL, the second apparatus 120 is a transmitting (TX) apparatus (or a transmitter) and the first apparatus 110 is a receiving (RX) apparatus (or a receiver). In UL, the first apparatus 110 is a TX apparatus (or a transmitter) and the second apparatus 120 is an RX apparatus (or a receiver).

It is to be understood that the number of devices and their connections shown in FIG. 1 are only for the purpose of illustration without suggesting any limitation. The communication environment 100 may include any suitable number of devices configured to implement example embodiments of the present disclosure. Although not shown, it would be appreciated that one or more additional devices may be located in the cell 102, and one or more additional cells may be deployed in the communication environment 100. It is noted that although illustrated as a network device, the network device 120 may be another device than a network device. Although illustrated as a terminal device, the terminal device 110 may be another device than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

Communications in the communication environment 100 may be implemented according to any proper communication protocol(s), comprising, but not limited to, cellular communication protocols, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

A unified TCI framework is introduced in some discussed schemes, which means that TCI states providing quasi co location (QCL) assumptions for the reception of DL signals and channels can be used also to provide spatial sources for the transmission of UL signals and channels to determine UL TX spatial filter.

In some discussed schemes, there is a pool of TCI states configured via the Radio Resource Control (RRC) and a subset of these configured TCI states is activated via the medium access control-control element (MAC-CE) with up to 8 TCI codepoints, each codepoint pointing to either separate or joint DL/UL TCI states.

The unified TCI framework also defines the concept of indicated TCI states, which can be joint DL/UL TCI states or separate DL and separate UL TCI states. That means that one or multiple (in a case of multiple transmission reception points (multi-TRP) for instance) of the configured TCI states is/are indicated TCI state(s) at a time.

Some discussed schemes introduced the unified TCI framework for single TRP (sTRP), with one indicated joint DL/UL TCI state at a time or one indicated separate DL and one indicated separate UL TCI state at a time for the UE.

Some further discussed schemes then extended the unified TCI framework for multiple TRP (mTRP), with two indicated joint TCI states at a time or two indicated separate DL and two indicated separate UL TCI states at a time for the UE.

Regarding the UEIBM, in some discussed schemes, some use cases where UE could benefit from initiating the UEIBM reporting are being identified (e.g., to facilitate beam switch). The UEIBM feature refers to the case where the UE may be configured with at least one event/condition, and then the UE may start beam reporting if this at least one event/condition occurs or is satisfied. The improvements aimed by this feature are twofold:
Reduce overhead, such that beam reports are sent by the UE only when needed, avoiding unnecessary beam reports that we may have in case of periodic reporting configured with small periodicities.
Reduce latency, such that, as soon as certain events/conditions are met, a beam report can be sent, to avoid long delay that we may have in case of periodic reporting configured with large periodicities.

In some discussed schemes, some specify enhancement related to MIMO comprises facilitating UE-initiated/event-driven beam management for reducing overhead and/or latency, assuming the unified TCI while leveraging (as much as possible) legacy channel state information (CSI) measurement and reporting configuration frameworks, targeting frequency range 2 (FR2) and sTRP with intra- and inter-cell beam management. Some enhancements related to the above mentioned scenario are as follows:
a. UL signalling content(s) (and procedure(s) as required) for UE-initiated/event-driven beam reporting facilitating fast beam switching
b. UL signalling medium/container considering the UE-initiated/event-driven nature of the UL transmission, designed primarily for the purpose of beam reporting

In the context of which event(s) may trigger a UE initiated (UEI) report, three events have been defined:
Event-2, where the quality of at least one new beam, such as Layer 1 reference signal received power (L1-RSRP), becomes a “threshold value” better than the current beam, has been agreed as the main event that can trigger a UEI report. For example, the network may configure the UE with a certain threshold, for example 3 dB, and when the UE measures a new beam to have a L1-RSRP which is 3 dB better than the L1-RSRP of the current beam, then a UEIBM report is triggered.
Event-1, where the quality of the current beam is worse than a certain threshold, may be used to avoid costly procedures like beam failure recovery (BFR).
Event-7, where the quality of at least one new beam, such as L1-RSRP, becomes a threshold value better than the reference signal (RS) derived from the activated TCI state with the Q-th best quality, may be used to update the active TCI state list. With Event-7 the UE does not expect that the configured Q is greater than the number of the activated DL/joint TCI states.

In the context of triggering event determination for Event-2, two options have been defined in some discussed schemes:
Basic functionality: Once the L1-RSRP of the new beam becomes a threshold value better than the current beam, UE initiated beam report occurs.
Subject to UE capability: If within a time window (which is configurable), the number of Event-2 instance(s) for at least one same new beam is greater than or equal to a configurable number M, UE initiated beam report occurs.

In the context of how these reports are sent back by the UE to the network, two procedures for actually sending back the report have been agreed in some discussed schemes:
Mode A, where the second UL channel for the UEI report is physical uplink shared channel (PUSCH) and it is dynamically scheduled by the gNB; in such procedure the following steps are implemented:
   a. The UE sends, in a first physical uplink control channel (PUCCH), a single-bit UL indication to request to the gNB resources in PUSCH to carry the UEI report;
   b. The gNB indicates via downlink control information (DCI) to the UE a PUSCH resource to carry the UEI report;
   c. The UE sends the UEI report on the scheduled PUSCH resource.
Mode B, where the second UL channel for the UEI report is configured grant-physical uplink shared channel (CG-PUSCH) pre-configured by the gNB; in such procedure the following steps are implemented:
   a. The UE sends, in a first PUCCH, a single-bit UL indication to notify to the gNB that a UEI report will be transmitted in a CG-PUSCH resource;
   b. UE sends the UEI report in the first CG-PUSCH resource X symbols after the first PUCCH, with X configured by the network.

As mentioned above, Mode A is the baseline and is going to be supported by all UEs capable of UEIBM. Mode B is optional and may be supported only by some UEs.

In the context of what to report, i.e., the UL signal content of the UEI report for Event-2 with L1-RSRP as quality metric, it has been agreed that the UE reports N beams, for example the top N beams, including for each beam the beam index (channel state information reference signal resource indication (CRI) or synchronization signals/physical broadcast channel block resource indicator (SSBRI)), RSRP and an indication if such beam triggered Event-2, with N≥1 configured by the network via RRC, and at least one of those N beams satisfies Event-2. Then, in addition to those N beams, the network may configure via RRC the UE to also report the current beam.

In the context of which RSs should be monitored/measured for current and new beams by the UE for Event-2, the UE is supposed to monitor the current beam and a certain number of new beams (note that “new” beams are sometimes referred to as well as “candidate beams” or “candidate new beams”). More specifically:
The RS(s) for the new beam(s) are explicitly configured by the network via RRC and can be either a set of synchronization signal and physical broadcast channel blocks (SSBs) or a set of CSI-RSs.
The RS for the current beam is related to the indicated TCI state, with an implicit method such that the current beam is either the actual RS in the indicated TCI state or the SSB which is quasi co-located (QCLed) with the actual RS in the indicated TCI state, depending on the configured set of new beams, to make sure that current and new beams are of the same “type”, e.g., either all SSBs or all CSI-RSs.

On one hand, Event-2 is considered in some discussed scheme as the main event, and most of the discussion in some discussed scheme defined the whole framework for such event.

On the other hand, for Event-1 and Event-7, it has been decided that Event-2 design will be re-used as much as possible, with only the changes needed because of the peculiarity of each event.

On UE-initiated/event-driven beam reporting, regarding trigger events, some working assumptions are confirmed that besides for Event-2, Event-1 and Event-7 are both supported. Some definitions related to Event-1 and Event-7 are shown as follows:
Event-1: Quality of the current beam is worse than a certain threshold.
Event-7: Quality of at least one new beam, such as L1-RSRP, becomes a threshold value better than the RS derived from the activated TCI state with the Q-th best quality.
   Q is RRC configured with subjective to UE capability signalling.
      UE may only indicate a single candidate value or not support Event-7.
The additionally supported events will reuse the same design as event 2—unless there is consensus to do otherwise.
The additionally supported events will be lower priority compared to event. 2.

For Event-7 one of the identified issues was on how to actually select the RS for the beam derived from the activated TCI state with the Q-th best quality, and it has been eventually decided to re-use the implicit method defined for Event-2 which is described below.

On UE-initiated/event-driven beam reporting, for Event 7, a scheme-1 and a scheme-2 for deriving ‘RS for current beam’ on Event-2 is reused and has been discussed with the following further interpretation:
Scheme-1: ‘RS for current beam’ is the QCL RS in the activated TCI state with the Q-th best quality.
Scheme-2: ‘RS for current beam’ is the SSB which is QCLed with the QCL RS in the activated TCI state with the Q-th best quality.
Basic feature of the triggering event determination for Event-7: Once the quality of at least one new beam becomes a threshold value better than the RS derived from the activated TCI state with the Q-th best quality, UE initiated beam report occurs.

For Event-2, regarding the scheme-1 and the scheme-2, some definitions are defined as follows:
Scheme-1: RS for current beam is the QCL RS in the indicated TCI state.
Scheme-2: RS for current beam is the SSB which is QCLed with the QCL RS in the indicated TCI state.

In the descriptions and definitions above, the term “current beam” has been used also for Event-7, creating a little bit of ambiguity, as “current beam” has also been used for Event-2 and Event-1 referring to the beam associated to the indicated TCI state. So, to avoid confusion, in the following, the term “reference beam” will be reused for Event-7 to refer to such RS in the activated TCI state with Q-th best quality, to distinguish from the “current beam” used for Event-2 associated to the indicated TCI state. Note that in certain embodiments however the reference may as well be associated to the indicated TCI state as for Event-2 and Event-1.

For Event-2, in some discussed schemes, there has been a new solution introducing a reset condition for the counter in case the UE is configured with time window and counter.

Regarding triggering event determination for Event 2, at least Candidate #2 is supported for resetting the counting, the detail of which is shown as follows:
Candidate #1: RS reconfiguration/update or MAC-CE signaling (if supported) for new beam is received.
   For future study (FFS): whether to reset the counting for all new beams.
   FFS: whether to maintain the counting whose new beam is not updated.
Candidate #2: [The measured current beam based on] indicated TCI state is updated.
   In such case, the UE need to reset the counting for all new beams.
Candidate #3: UEI beam report is transmitted.
   FFS: Only reset the counting of new beams fulfilling triggering condition and reported by the UEI beam report.
Candidate #4: NW response (e.g., DCI in step-2 of Mode-A) is detected.
Candidate #5: The time window expires.
Candidate #6: The threshold for event evaluation is re-configured by RRC signaling.
(FFS) Candidate #7: The RRC parameter(s) associated with the CSI report configuration for UEI beam report is reconfigured.
   FFS: RRC parameter(s)
FFS: Other candidates.

As described above, the main technical problem is that, in certain scenarios, there could be some ambiguity about how Event-2 is triggered at UE. For example, in case the UE receives a DCI command to update the indicated TCI state within a configured time window, then the current beam would be changing within the time window itself. Because of such reason, it has been decided that, if such DCI command to update the indicated TCI state is transmitted by the network, then the UE will reset the counter (Candidate #2) above for all new beams.

The Candidate #2 solution for resetting the counter for Event-2 is applicable to Event-1 but it is not applicable/helpful for Event-7. In fact, the UE in Event-7 compares the new beams against the reference beam, which is associated to the TCI state with the Q-th best quality.

Different from Event-2 where the current beam is a) uniquely identified by the indicated TCI state and b) can be fully and directly controlled by the network for example updating the indicated TCI state using a DCI command, for Event-7 there is not such unique identification for the reference beam, which then cannot be directly and uniquely updated/controlled by the network. In case a time window and counter are configured, the Event-7 reference beam may even change during the time window just because of varying RSRP.

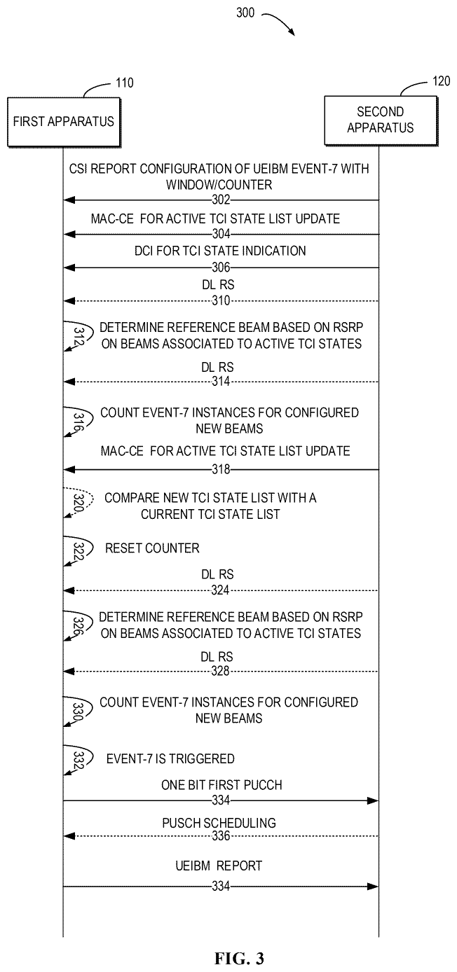

FIG. 2 illustrates an example of a change of reference beam within the configured time window for Event-7 determination. As shown in FIG. 2, in a case where Event 7 is configured with Q=2 and three active TCI states, there is a certain active TCI state (e.g., TCI #3) used as reference beam in the first part of the window and another active TCI state (e.g., TCI #2) used as reference beam in the second part of the window.

Therefore, how to define reset conditions for the counter with Event-7 may still need to be discussed.

Embodiments of the present disclosure provide a solution for a reset condition for UEIBM triggered by an event, for example event 1, event 2 or event 7. In this solution, the first apparatus 110 receives a CSI report configuration indicating a condition for a trigger event associated with a set of new beams to be measured by the first apparatus and a signaling command for a TCI state activation of the first apparatus. Then the first apparatus 110 may reset a counter associated with a counting of at least one new beam based on the reception of the signaling command and the CSI report configuration.

Example embodiments of the present disclosure will be described in detail below with reference to the accompanying drawings.

Reference is now made to FIG. 3, which shows a signaling chart 300 of communication according to some example embodiments of the present disclosure. As shown in FIG. 3, the signaling chart 300 involves a first apparatus 110 and a second apparatus 120. For the purpose of discussion, reference is made to FIG. 1 to describe the signaling chart 300.

As shown in FIG. 3, the first apparatus 110 may be configured with a UEIBM event 7 with a counter and/or a window. For example, the first apparatus 110 receives (302) a channel state information (CSI) report configuration from the second apparatus 120. The CSI report configuration may indicate a condition for a trigger event associated with a set of new beams to be measured by the first apparatus. For example, for event 7, the condition for the trigger event associated with the set of new beams may comprise a set of new beams being measured to be a threshold value better than a reference beam.

The second apparatus 120 may transmit (304) to the first apparatus 110, a MAC-CE for active TCI state list update. Then the second apparatus 120 may transmit (306) to the first apparatus 110, DCI for TCI state indication. The TCI state(s) indicated in the DCI may be referred to as indicated TCI state(s), which may be joint DL/UL TCI state(s) or separate DL and separate UL TCI state(s).

The second apparatus 120 may send (310) one or more DL RSs to the first apparatus 110, e.g., for RS measurement(s). For example, the first apparatus 110 may determine (312) a reference signal based on RSRP measurements on beams associated with the active TCI states. The reference beam may be associated with a TCI state with a predefined quality by a value included in the configuration.

The second apparatus 120 may send (314) one or more further DL RSs to the first apparatus 110. For example, the first apparatus 110 may count (316) event-7 instances for configured new beams, e.g., by the counter configured by the CSI report configuration. That is, the counter starts counting. The new beam counting by the first apparatus may be within a time window for determining that the condition for the trigger event is met.

The second apparatus 120 may transmit (318) a signaling command for a TCI state activation at the first apparatus 110, which may indicate an active TCI state list update. The signaling command used hereinafter may be referred to as a MAC-CE command or an RRC command.

As an option, for the first apparatus 110 configured with a CSI report configuration associated to Event-7 for UEIBM using evaluation window and counter, if the first apparatus 110 receives this signaling command to update the active TCI state list, the first apparatus 110 may reset (322) the counter associated with a counting of at least one new beam. In this case, the reset of the counter may be done for any signaling command that updates the active TCI state list.

As an example, for the first apparatus 110 configured with a CSI report configuration indicating a condition for event 7 comprising a set of new beams being measured to be a threshold value better than a reference beam, resetting the counter associated with a counting of at least one new beam may refer to a counting of all new beams belonging to the set of new beams. In this case, the reset of the counter may be done for all new beams that are monitored by the first apparatus 110, i.e., all beams whose RSRP is compared against the RSRP of the reference beam.

As another example, resetting the counter associated with a counting of at least one new beam may refer to a counting of a subset of the set of new beams.

As another option, for the first apparatus 110 configured with a CSI report configuration associated to Event-7 for UEIBM using evaluation window and counter, if the first apparatus 110 receives this signaling command to update the active TCI state list, the first apparatus 110 may compare (320) the new TCI state list with a current TCI state list and determine whether the counter is to be reset based on the comparison.

For example, the reset of the counter may be done only for certain signaling commands that update the active TCI state list.

In some example embodiments, the reset of the counter may be done only for a signaling command that does not include in the new/updated TCI state list all the active TCI states of the current TCI state list. That is, all active TCI states of the first apparatus 110 are to be updated by one or more activated TCI states, that are different from the all active TCI states, indicated in the signaling command.

For example, assume that the first apparatus 110 is configured with Event-7 UEIBM with Q=2 and has an active TCI state list including the three TCI states X, Y, and Z. If the first apparatus 110 receives a signaling command updating the list to a new one including the three completely new TCI states A, B, and C, then for sure the reference beam has been updated, and the first apparatus 110 may accordingly reset (322) the counter.

In some other example embodiments, the reset of the counter may be done only for a signaling command that does not include in the new/updated TCI state list all the active non-indicated TCI states of the current TCI state list. That is, active TCI states, in a current active TCI state list of the first apparatus excluding an indicated TCI state, are to be updated by one or more activated TCI states indicated in the signaling command.

For example, assume that the first apparatus 110 is configured with Event-7 UEIBM with Q=2 and has an active TCI state list including the three TCI states X, Y, and Z, with X being the indicated one. If the first apparatus 110 receives a signaling command updating the list to a new one including the four TCI states X, A, B, and C, then, under the assumption that the indicated TCI state was the best, the reference beam has been updated, and the first apparatus 110 may accordingly reset (322) the counter.

An active TCI state as described above may be referred to as a joint DL/UL TCI state (if joint DL/UL TCI states are configured) or only a separate DL TCI state (if separate DL and UL TCI states are configured) of the current TCI state list are compared against the new/updated TCI state list.

In some example embodiments, the reset of the counter takes effect when the first apparatus 110 may be required to update the active TCI state list based on the signaling command.

For example, the first apparatus 110 that receives a signaling command to update the TCI state list at slot n may be required to perform the update of the active TCI state list by slot n+T, where T can have different expressions/values, for example depending on the fact that TCI states are “known” or “unknown”.

In some example embodiments, the reset of the counter may be done for any signaling command that includes a number of activated TCI states smaller than Q.

Although the first apparatus 110 does not expect that the number of active TCI states is less than Q, this unexpected MAC-CE could be used as a condition to reset the counter.

As an option, such MAC-CE including a number of activated TCI states smaller than Q may be an implicit message to deactivate the CSI report configuration associated to Event-7, i.e., after such MAC-CE Event-7 cannot trigger any further report.

As another option, the number of either the joint DL/UL TCI states (if joint DL/UL TCI states are configured) or only the separate DL TCI states (if separate DL and UL TCI states are configured) is compared against Q.

In some other example embodiments, only the first S activated TCI states may be considered as the activated TCI states, irrespective of a larger number of activated TCI states in the signaling command, where S depends on the used DCI format for TCI indication.

In this case, the first apparatus 110 may be expected either to be configured with Q≤S or defined to consider Q=S if Q is configured to be larger than S.

These embodiments may relate to the fact that for certain DCI formats, for example DCI 1_2, S is the number of codepoints in DCI that can be smaller than the number of activated TCI states in MAC-CE. In such cases, only the first S activated TCI states (from MAC-CE) are applied for TCI indication. In summary, the first apparatus 110 may only worry about the first S activated TCI states.

For example, if the first S activated TCI states of the current TCI state list are also the first S activated TCI states of the new/updated TCI state list, then no reset happens.

As another example, if any of the first S activated TCI states of the current TCI state list is not among the first S activated TCI states of the new/updated TCI state list, then reset happens.

Embodiments of the present disclosure may also propose a dynamic indication of Q together with TCI state activation via MAC-CE. As discussed, the network activating less than Q TCI states may be an error case. To activate less than Q TCI states, the network first has to reconfigure the first apparatus 110 with a new Q via an RRC signaling, and only then use the MAC-CE to activate a number of TCI states equal to or less than Q. This is time consuming, and hence to avoid this, a dynamic indication of a new Q together with TCI activation can be used.

Therefore, it is possible that the reset of the counter may be done for any MAC-CE including an indication of a new Q, as that may very likely update the reference beam. That is, if the first apparatus 110 determines that the MAC CE indicating an update of value of Q, the first apparatus 110 may reset the counter.

In some embodiments, if the number of activated TCI states is less than the updated value of Q, the first apparatus 110 may deactivate the received CSI report configuration.

The conditions, as described above, for resetting the counter with Event-7 are applicable irrespective of the type of evaluation window, which may be sliding or fixed with respect to the transmission of the first PUCCH.

The embodiments as described above may also apply for both the following use cases regarding MAC-CE content, i.e., MAC-CE fully replacing all TCI states in the active TCI state list: for example, a UE taking a corner of a building, with total changes in the radio channel conditions before and after taking the corner and MAC-CE just partially replacing some of the TCI states in the active TCI state list: most common scenario, with a UE moving for example along a street with radio channel conditions changing more gradually with respect to the example just above.

Referring back to FIG. 3, the second apparatus 120 may send (324) one or more DL RSs to the first apparatus 110, e.g., for RS measurement(s). For example, the first apparatus 110 may determine (326) a reference signal based on RSRP measurements on beams associated with the active TCI states. The reference beam may be associated with a TCI state with a predefined quality by a value included in the configuration.

The second apparatus 120 may send (328) one or more further DL RSs to the first apparatus 110. For example, the first apparatus 110 may count (330) event-7 instances for configured new beams, e.g., by the counter configured by the CSI report configuration. That is, the counter starts counting. The new beam counting by the first apparatus may be within a time window for determining that the condition for the trigger event is met.

Upon determining the event-7 is triggered (332) at the first apparatus 110, the first apparatus 110 may send (334) a single bit first PUCCH to inform a UEIBM is to be reported to the network. Only for mode A, the second apparatus 120 may send (336) DCI for scheduling the PUSCH for beam report.

Then the first apparatus 110 may send (338) the beam report (i.e., UEIBM) triggered by event-7 on the PUSCH.

Based on the solutions of the present disclosure, it is simple with no ambiguity on when/if the counter needs (or does not need) to be reset and this is controlled by the network.

FIG. 4 shows a flowchart of an example method 400 implemented at a first apparatus in accordance with some example embodiments of the present disclosure. For the purpose of discussion, the method 400 will be described from the perspective of the first apparatus 110 in FIG. 1.

At block 410, the first apparatus 110 receives, from a second apparatus, a CSI report configuration indicating a condition for a trigger event associated with a set of new beams to be measured by the first apparatus.

At block 420, the first apparatus 110 receives, from a second apparatus, a signaling command for a TCI state activation of the first apparatus.

At block 430, the first apparatus 110 resets a counter associated with a counting of at least one new beam based on the reception of the signaling command and the CSI report configuration.

In some example embodiments, the at least one new beam comprises a subset of the set of new beams or all new beams belong to the set of new beams.

In some example embodiments, the method 400 further comprises: in accordance with a determination that a current active TCI state list of the first apparatus is to be updated by a new active TCI state list indicated in the signaling command, resetting the counter.

In some example embodiments, the method 400 further comprises: in accordance with a determination that all active TCI states of the first apparatus are to be updated by one or more activated TCI states indicated in the signaling command, resetting the counter.

In some example embodiments, the method 400 further comprises: in accordance with a determination that active TCI states, in a current active TCI state list of the first apparatus excluding an indicated TCI state, are to be updated by one or more activated TCI states indicated in the signaling command, resetting the counter.

In some example embodiments, the method 400 further comprises: resetting the counter at a time point when the first apparatus is required to update the at least one active state of the first apparatus based on the signaling command.

In some example embodiments, the method 400 further comprises: in accordance with a determination that the number of activated TCI states, indicated in the signaling command for the updating, is less than a pre-defined value, resetting the counter.

In some example embodiments, the signaling command indicates a deactivation of a channel state information (CSI) report configuration associated with a specific event at the first apparatus.

In some example embodiments, an active TCI state comprises joint downlink (DL) and uplink (UL) TCI states or separate DL TCI states.

In some example embodiments, the method 400 further comprises: in accordance with a determination that first one or more active TCI states in a current active TCI state list of the first apparatus are not among first one or more activated TCI states indicated in the signaling command for the updating, resetting the counter.

In some example embodiments, the number of the first one or more active TCI states equals to the number of first one or more activated TCI states.

In some example embodiments, the reference beam is associated with a TCI state with a predefined quality by a value included in the CSI report configuration.

In some example embodiments, the new beam counting by the first apparatus is within a time window for determining that the condition for the trigger event is met.

In some example embodiments, the method 400 further comprises: in response to the condition for the trigger event being met, transmitting a beam report to the second apparatus.

In some example embodiments, the condition for the trigger event associated with the set of new beams being measured comprises: determining one or more new beams of the set of new beams to be a threshold value better than a reference beam.

In some example embodiments, the signaling command comprises a medium access control (MAC) control element (CE) or a radio resource control (RRC) command.

In some example embodiments, the first apparatus comprises a terminal device and the second apparatus comprises a network device.

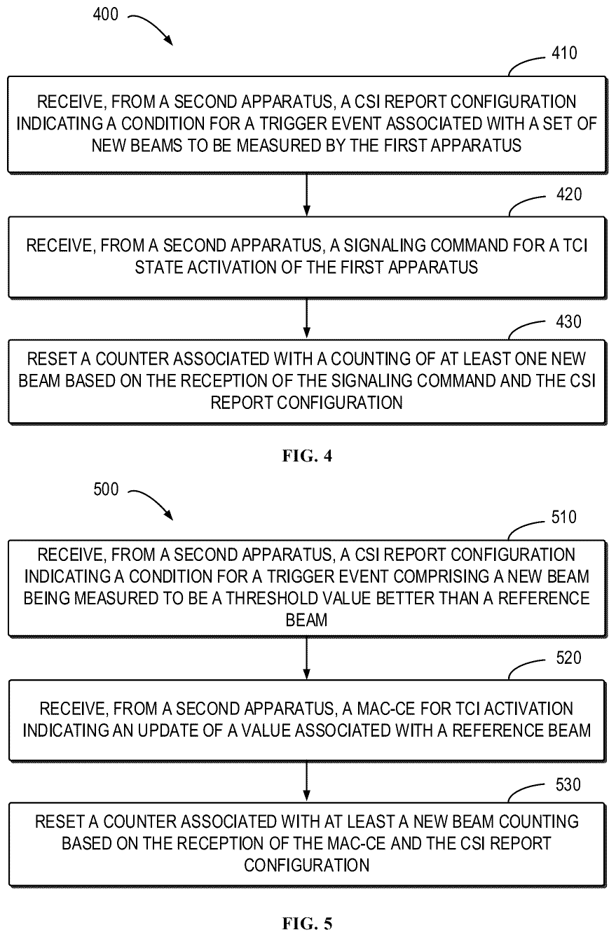

FIG. 5 shows a flowchart of an example method 500 implemented at a first apparatus in accordance with some example embodiments of the present disclosure. For the purpose of discussion, the method 500 will be described from the perspective of the first apparatus 110 in FIG. 1.

At block 510, the first apparatus 110 receives, from a second apparatus, a CSI report configuration indicating a condition for a trigger event comprising a new beam being measured to be a threshold value better than a reference beam.

At block 520, the first apparatus 110 receives, from a second apparatus, a MAC-CE for TCI activation indicating an update of a value associated with a reference beam.

At block 530, the first apparatus 110 resets a counter associated with at least a new beam counting based on the reception of the MAC-CE and the CSI report configuration.

In some example embodiments, the value corresponds to a quality of a reference signal associated with a TCI state, and wherein the reference beam is associated to the TCI state.

In some example embodiments, the method 500 further comprises: in accordance with a determination that the value is updated based on the MAC-CE, changing the reference beam.

In some example embodiments, the number of TCI states to be activated by the MAC-CE is allowed to be less than or equal to the updated value.

In some example embodiments, the method 500 further comprises: in accordance with a determination that the number of activated TCI states is less than the updated value, deactivating a channel state information (CSI) report configuration.

In some example embodiments, the reference beam is associated with a TCI state with a predefined quality by a value included in the CSI report configuration.

In some example embodiments, the new beam counting by the first apparatus is within a time window for determining that the condition for the trigger event is met.

In some example embodiments, the method 500 further comprises: in response to the condition for the trigger event being met, transmitting a beam report to the second apparatus.

In some example embodiments, the first apparatus comprises a terminal device and the second apparatus comprises a network device.

In some example embodiments, a first apparatus capable of performing any of the method 400 (for example, the first apparatus 110 in FIG. 1) may comprise means for performing the respective operations of the method 400. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a CSI report configuration indicating a condition for a trigger event associated with a set of new beams to be measured by the first apparatus; means for receiving, from a second apparatus, a signaling command for a TCI state activation of the first apparatus; and means for resetting a counter associated with a counting of at least one new beam based on the reception of the signaling command and the CSI report configuration.

In some example embodiments, the at least one new beam comprises a subset of the set of new beams or all new beams belong to the set of new beams.

In some example embodiments, the first apparatus further comprises: means for in accordance with a determination that a current active TCI state list of the first apparatus is to be updated by a new active TCI state list indicated in the signaling command, resetting the counter.

In some example embodiments, the first apparatus further comprises: means for in accordance with a determination that all active TCI states of the first apparatus are to be updated by one or more activated TCI states indicated in the signaling command, resetting the counter.

In some example embodiments, the first apparatus further comprises: means for in accordance with a determination that active TCI states, in a current active TCI state list of the first apparatus excluding an indicated TCI state, are to be updated by one or more activated TCI states indicated in the signaling command, resetting the counter.

In some example embodiments, the first apparatus further comprises: means for resetting the counter at a time point when the first apparatus is required to update the at least one active state of the first apparatus based on the signaling command.

In some example embodiments, the first apparatus further comprises: means for in accordance with a determination that the number of activated TCI states, indicated in the signaling command for the updating, is less than a pre-defined value, resetting the counter.

In some example embodiments, the signaling command indicates a deactivation of a channel state information (CSI) report configuration associated with a specific event at the first apparatus.

In some example embodiments, an active TCI state comprises joint downlink (DL) and uplink (UL) TCI states or separate DL TCI states.

In some example embodiments, the first apparatus further comprises: means for in accordance with a determination that first one or more active TCI states in a current active TCI state list of the first apparatus are not among first one or more activated TCI states indicated in the signaling command for the updating, resetting the counter.

In some example embodiments, the number of the first one or more active TCI states equals to the number of first one or more activated TCI states.

In some example embodiments, the reference beam is associated with a TCI state with a predefined quality by a value included in the CSI report configuration.

In some example embodiments, the new beam counting by the first apparatus is within a time window for determining that the condition for the trigger event is met.

In some example embodiments, the first apparatus further comprises: means for in response to the condition for the trigger event being met, transmitting a beam report to the second apparatus.

In some example embodiments, the condition for the trigger event associated with the set of new beams being measured comprises: determining one or more new beams of the set of new beams to be a threshold value better than a reference beam.

In some example embodiments, the signaling command comprises a medium access control (MAC) control element (CE) or a radio resource control (RRC) command.

In some example embodiments, the first apparatus comprises a terminal device and the second apparatus comprises a network device.

In some example embodiments, a first apparatus capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1].

In some example embodiments, the first apparatus comprises means for receiving, from a second apparatus, a CSI report configuration indicating a condition for a trigger event comprising a new beam being measured to be a threshold value better than a reference beam; means for receiving, from a second apparatus, a MAC-CE for TCI activation indicating an update of a value associated with a reference beam; and means for resetting a counter associated with at least a new beam counting based on the reception of the MAC-CE and the CSI report configuration.

In some example embodiments, the value corresponds to a quality of a reference signal associated with a TCI state, and wherein the reference beam is associated to the TCI state.

In some example embodiments, the first apparatus further comprises: means for in accordance with a determination that the value is updated based on the MAC-CE, changing the reference beam.

In some example embodiments, the number of TCI states to be activated by the MAC-CE is allowed to be less than or equal to the updated value.

In some example embodiments, the first apparatus further comprises: means for in accordance with a determination that the number of activated TCI states is less than the updated value, deactivating a channel state information (CSI) report configuration.

In some example embodiments, the reference beam is associated with a TCI state with a predefined quality by a value included in the CSI report configuration.

In some example embodiments, the new beam counting by the first apparatus is within a time window for determining that the condition for the trigger event is met.

In some example embodiments, the first apparatus further comprises: means for in response to the condition for the trigger event being met, transmitting a beam report to the second apparatus.

In some example embodiments, the first apparatus comprises a terminal device and the second apparatus comprises a network device.

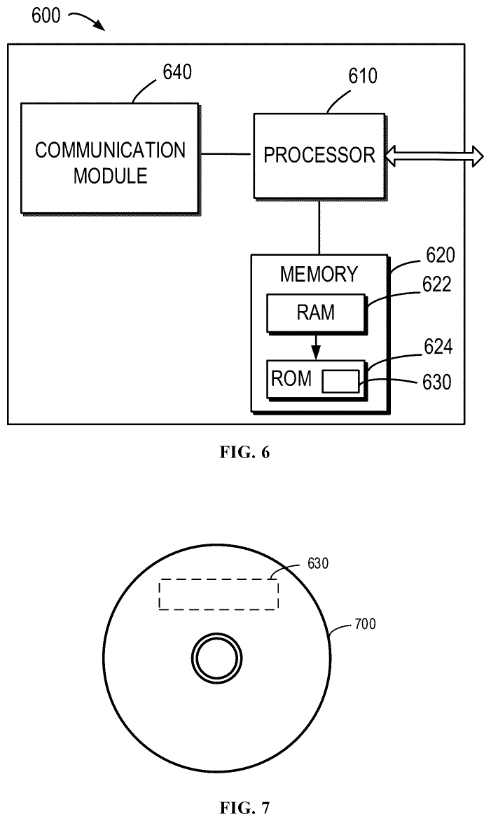

FIG. 6 is a simplified block diagram of a device 600 that is suitable for implementing example embodiments of the present disclosure. The device 600 may be provided to implement a communication device, for example, the first apparatus 110 or the second apparatus 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment.

Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus to:
receive, from a second apparatus, a channel state information (CSI) report configuration indicating a condition for a trigger event comprising a new beam being measured to be a threshold value better than a reference beam;
receive, from a second apparatus, a medium access control (MAC) control element (CE) for transmission configuration indicator (TCI) activation indicating an update of a value associated with a reference beam; and
reset a counter associated with at least a new beam counting based on the reception of the MAC-CE and the CSI report configuration.

2. The first apparatus of claim 1, wherein the value corresponds to a quality of a reference signal associated with a TCI state, and wherein the reference beam is associated to the TCI state.

3. The first apparatus of claim 1, wherein the first apparatus is caused to:
in accordance with a determination that the value is updated based on the MAC-CE, change the reference beam.

4. The first apparatus of claim 1, wherein the number of TCI states to be activated by the MAC-CE is allowed to be less than or equal to the updated value.

5. The first apparatus of claim 1, wherein the first apparatus is caused to:
in accordance with a determination that the number of activated TCI states is less than the updated value, deactivate a CSI report configuration.

6. The first apparatus of claim 1, wherein the reference beam is associated with a TCI state with a predefined quality by a value included in the CSI report configuration.

7. The first apparatus of claim 1, wherein the new beam counting by the first apparatus is within a time window for determining that the condition for the trigger event is met.

8. The first apparatus of claim 1, wherein the first apparatus is caused to:
in response to the condition for the trigger event being met, transmit a beam report to the second apparatus.

9. The first apparatus of claim 1, wherein the first apparatus comprises a terminal device and the second apparatus comprises a network device.

10. A method comprising:
receiving, from a second apparatus, a channel state information (CSI) report configuration indicating a condition for a trigger event comprising a new beam being measured to be a threshold value better than a reference beam;
receiving, from a second apparatus, a medium access control (MAC) control element (CE) for transmission configuration indicator (TCI) activation indicating an update of a value associated with a reference beam; and
resetting a counter associated with at least a new beam counting based on the reception of the MAC-CE and the CSI report configuration.

11. The method of claim 10, wherein the value corresponds to a quality of a reference signal associated with a TCI state, and wherein the reference beam is associated to the TCI state.

12. The method of claim 10, wherein the method further comprising:
in accordance with a determination that the value is updated based on the MAC-CE, changing the reference beam.

13. The method of claim 10, wherein the number of TCI states to be activated by the MAC-CE is allowed to be less than or equal to the updated value.

14. The method of claim 10, wherein the method further comprising:
in accordance with a determination that the number of activated TCI states is less than the updated value, deactivating a CSI report configuration.

15. The method of claim 10, wherein the reference beam is associated with a TCI state with a predefined quality by a value included in the CSI report configuration.

16. The method of claim 10, wherein the new beam counting by the first apparatus is within a time window for determining that the condition for the trigger event is met.

17. The method of claim 10, wherein the method further comprising:
in response to the condition for the trigger event being met, transmit a beam report to the second apparatus.

18. A computer program product comprising instructions stored thereon for causing a first apparatus at least to perform:
receiving, from a second apparatus, a channel state information (CSI) report configuration indicating a condition for a trigger event comprising a new beam being measured to be a threshold value better than a reference beam;
receiving, from a second apparatus, a medium access control (MAC) control element (CE) for transmission configuration indicator (TCI) activation indicating an update of a value associated with a reference beam; and
resetting a counter associated with at least a new beam counting based on the reception of the MAC-CE and the CSI report configuration.

19. The computer program product of claim 18, wherein the new beam counting by the first apparatus is within a time window for determining that the condition for the trigger event is met.

20. The computer program product of claim 18, wherein the first apparatus is caused to perform:
in response to the condition for the trigger event being met, transmitting a beam report to the second apparatus.
